(19) United States
(12) Patent Application Publication
(10) Pub. No.: US 2020/0160465 A1
(43) Pub. Date: May 21, 2020

(54) System and Method of IP Ownership and IP Transactions with Guaranteed Buy Valuation and Broker Rewards

(71) Applicants: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(72) Inventors: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(21) Appl. No.: 16/435,434

(22) Filed: Jun. 7, 2019

Related U.S. Application Data
(63) Continuation-in-part of application No. 16/388,682, filed on Apr. 18, 2019.

(30) Foreign Application Priority Data
Oct. 19, 2018 (US) PCT/US2018/056690

(51) Int. Cl. G06Q 50/18; G06Q 30/00; G06Q 20/38; G06Q 40/04

(52) U.S. Cl. CPC G06Q 50/184; G06Q 40/04; G06Q 20/389; G06Q 30/018

(57) ABSTRACT

The present invention envisions a comprehensive platform (the “IPwe Platform”) that utilizes blockchain and smart contracts to address and improve upon the significant deficiencies that currently exist in the global IP market (patents, trademarks, copyrights, etc.). The objective of the IPwe Platform is creating transparency in (i) patent ownership, (ii) patent identification and (iii) patent coverage and value. In addition, by providing the network, a guaranteed buy program can be initiated that provides specific guaranteed value to intellectual property assets listed by verified brokers.

### PRIORITY CLAIMS

This application is a continuation in part of U.S. patent application Ser. No. 16/388,682, filed on Apr. 18, 2019, which is a continuation in part of International Patent Application No. PCT/US2018/056690, filed Oct. 19, 2018, and is incorporated herein by reference.

### BACKGROUND

Intellectual Property, including patents, trademarks, and copyrights are critical assets that promote innovation, encourage investment, economic growth and knowledge sharing. Having been considered the exclusive provenance of attorneys and other technical intermediaries, these assets have been delegated to registration-based systems controlled by separate centralized authorities. The introduction of blockchain and smart contracts however, may play a critical role in unlocking the value in those assets.

With specific reference to patents, historians trace the roots of the patent system back 600 years before the Common Era—initially granting the creators of new recipes exclusive rights to the recipes they developed and disclosed.¹ The first industrial patents were granted by kings in the 1400's and the first patent laws were developed by the Venetians and enacted in the late 1400's.² The conceptual societal bargain underpinning patents is very simple: the inventor of something new makes a public disclosure of that innovation and in exchange is given exclusive rights, to that innovation for a limited period of time. Stated otherwise, the holder of the patent is given a time limited monopoly related to that invention. Accordingly, the Patent system was intended to promote innovation. ¹ [“Six significant moments in patent history,” https://www.reuters.com/article/us-moments-patent/six-significant-moments-in-patent-history-idUSKBN0IN1Y120141104, 2014.]² Same.

Over time, the concept of patents has evolved globally and become critical in the development of innovation, jobs and prosperity.³ For example, in the United States, the framers of the Constitution felt that patents were so critical to the development of the economy that they provided a specific provision for patents in Article I of the US Constitution. In China, the first patent laws were not adopted until 1984, yet today, China leads the world in the annual number of patent applications filed. In fact, in the last 30 years China has become one of the leading forces in the patent market. Emerging and developing countries are making notable efforts to promote patents and are investing in the development of patent systems to promote prosperity. Most major developed countries have a specific patent system. ³ https://www.brookings.edu/wp-content/uploads/2016/06/patenting-prosperity-rothwell.pdf

Within the current patent ecosystem patents fall under a corporate asset class known as Intangibles. Today, US companies are worth about $14.5 trillion in Intangibles alone.⁴ Global research and development expenditure on intangibles is $1.9 trillion USD, and generally closely tracks patent filings and grants.⁵ In fact in 1975, the S&P 500 market value of intangible assets was 17%. In 2015, the S&P 500 market value of intangible assets grew to 87%.⁶ This change to a knowledge economy makes patents even more important. ⁴ “Annual licensing and royalty revenues now total $180 billion, says new WIPO report,” http://www.iam-media.com/blog/detail.aspx?g=acd471eb-956d-4103-bb63-ac75d04fc068, 2011.⁵ “2016 Global R&D Funding Forecast,” https://www.iriweb.org/sites/default/files/2016GlobalR%26DFundingForecast_2.pdf, 2016.⁶ “Annual Study of Intangible Asset Market Value from Ocean Tomo, LLC,” http:www.oceantomo.com/2015/03/04/2015-intangible-asset-market-value-study/, 2015.

This ecosystem further constitutes a variety of stakeholders. Stakeholders include principals, intermediaries, and other participants. For example, patents are often driven by innovators such as technologists, research and development teams, and inventors. The patents themselves are regulated by national offices, patent examiners, and various courts. Patents are practiced by principals such as corporate, university, government or individual owners. They are written and fought over by an entire economy of legal professionals including patent agents, patent litigators, and patent prosecutors. Patents are often analyzed and evaluated by brokers, claims analysts, validity analysts, experts, and reverse engineering experts. They can be evaluated by financial advisers in litigation or for insurance purposes.

As a result, the patent market is highly segregated and globalized. This leads to a variety of different issues. The technologists are brilliant at invention and innovating, but they typically drop out of the patent process once the invention takes shape and turn it over to a specialized group of lawyers that handle patent prosecution. The prosecuting attorneys focus on examiners at the relevant national patent office that grant patents and generally focus solely on endeavoring to obtain an allowed patent—with little regard for the litigation impacts down the road. Patent examiners at national patent offices perform the critical function of approving patent grants, but are forced to operate under limited budgets and often face poor and consistent guidance. In fact, systems examiners use to research and evaluate patents are largely dated and simply not up to standards which result in inefficient time allocation and, ultimately, poorer quality patents.

After a patent is granted it is typically handed off to a new group—often with a different focus, including attorneys and licensing professionals. These professionals struggle to keep up with a flood of information that makes it difficult for them to succeed—all the while they are steeped in a tradition that encourages a lack of transparency. After issuance, and during the patent's typically 20-year life, there are multiple other intermediaries who may become involved such as brokers, reverse engineering contractors, experts, transaction specialists and more lawyers—and occasionally, courts and governmental administrative agencies. As the asset class has started to evolve, over the last 25 years investors, insurance, lenders and other financial intermediaries have begun to take an interest in patents. Financial intermediaries' interest and level of participation has been limited by the issues associated with the patent asset class.

While these intermediaries typically work diligently to achieve a specific objective, they all contribute to the inefficiency and a lack of transparency that impedes innovation, and ultimately negatively impacts the patent asset class. As a result, technologists, executives and companies that could benefit from this asset class, avoid it and often either ignore or delegate the management of this asset class to even more lawyers and intermediaries.

In addition to the segregated relationships between patent stakeholders, Current national office patent registry systems are established via convention, laws and regulations enacted by various governments. As a result of the lack of standards with international scope, the current electronic patent registry solution functions as multiple disparate incompatible sets of siloed data which must be manually parsed and translated. Even though various entities such as the World International Patent Office have attempted to form a single system for patent practice, the global economy has made it difficult to obtain patents in multiple economies without expending significant resources across to navigate a complex system involving multiple governmental organizations.

### SUMMARY

If you were to sit down with a large team of intellectuals and attempt to design a more complex global system for prosecuting and recording patent ownership, determining if there is a patent relevant to a technology, valuing a patent and transacting in patents, you may not reach a resolution. There are numerous why such a system would be complicated, including that the historical patent systems were put in place long before the digital age and the varied regulations developed by numerous national patent offices (the governmental agencies responsible for issuing and regulating patents). As with many emerging asset classes, there is limited motivation for the market to innovate to address these issues because certain intermediaries (primarily lawyers) benefit from these inefficiencies.

Three core problems that surround the current Patent market include:

Lack of transparency on patent ownership
Difficulty in establishing patent identification, coverage and value
The substantial liquidity discount ascribed to patents because of these issues

One potential issue related to the current patent systems around the world relates to determining ownership. Determining who owns a patent should be a simple task that can be easily accomplished in seconds. This is simply not the case with patents. Patents are granted by governmental and quasi-governmental agencies called “national offices.” Each country has its own national patent office. For example, in the US the United States Patent and Trademark Office (USPTO) is an approximate 13,000-person agency where patent applications are filed and after a typically multi-year review process approximately 55% are granted. Currently there are 191 national offices that each operate with their own individual byzantine collection of rules and procedures and industry customs that has resulted in a set of practices and regulations that reduce transparency. Ownership information is complicated to record at the various national offices. There are often significant administrative delays and mistakes in recording ownership information. This is exacerbated by paper systems, transcription errors, translation errors (national offices largely conduct business in their native language), no naming conventions (many companies around the world have similar names), changes in ownership for a variety of reasons over a patent's 20-year life, no centralized system to update ownership changes across multiple jurisdictions and the expense associated with recording updated ownership information. In addition, there are certain patent owners that believe it is best to obscure ownership information by either simply not recording ownership information in a timely manner or recording the information in the name of remote entities where it is difficult to tie the patent to a parent entity. The simple ability to determine who owns the patent will promote patent transactions.

Another issue related to the way patents are registered revolves around the categorization or classification of various patents. Specifically, determining if a patent exists in a technology area and determining what it covers is difficult, if not impossible to achieve in the current system with any level of certainty without incurring significant expense. There are over six million global patents and an approximately equal number of patent applications pending. Simply identifying if a patent exists is a challenge since there is no global centralized patent database. Taking the next step and attempting to discover whether a patent exists in a technology area is even more difficult. Assuming one identifies that a patent exists and that it relates to a technology area, determining the likely scope of what the patent covers and if it valid is difficult in the current system and extremely expensive. Determining if a product you are about to launch may infringe a patent is so difficult that is has become common practice not to even ask this question. “Efficient infringement” practices arose in the US for several reasons, but the shear difficulty in making an informed decision leads companies to ignore patent rights.

A third issue related to patents has to do with valuation of the assets. Currently, there is no agreement in the market on “patent value” or the appropriate method to determine value. There is no market for a large percentage of the patents that exist simply because it is extremely difficult to establish a value. The current ultimate arbiter of value for patents are judges and a court system that are ill-suited for this role.

Because of the problems identified above with the patent asset class, innovation suffers as this incredible store of knowledge is kept hidden and obscured resulting in substantial amounts of capital being trapped and significant liquidity discounts being required to stimulate transactions. Investment activity in patents and the innovation they represent and inventions and the commercial opportunities that are represented by these patents, is being stifled by a system that deters transparency and efficient price discovery. In addition to these macro impacts, these problems in the patent market manifest themselves in many other ways, including giving rise to the patent arbitrage opportunities exploited by “patent trolls,” general patent litigation, valuable technologies that simply are not identified that fail to receive funding, wasted R&D dollars “discovering” what already exists, the disincentive to invest in innovation and exorbitant intermediary costs.

Current solutions to the problem are expensive and not efficient. For example, there are several patent analytic tools available in the market, including Innography, PatSeer, ClearstoneIP, IP.com, Patsnap and various free services. Most of these pay tools charge annual fees that are over $10,000 per seat per year.

The current invention proposes a method of solving the issues associated with the patent ecosystem and the IP system as a whole, is to use a decentralized approach via blockchain technology. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.⁷ ⁷ “Ethereum Whitepaper,” http://github.ethereum/wiki/white-paper, 2016

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

The proposed method envisions a tool powered by smart contracts, and combines several approaches from the legal and payment industries into a blockchain format. With blockchain as the core technology, the present invention further proposes a Registry (“IPwe Registry”) as a Decentralized Application (“DApp”) that will allow each party to a patent transaction—including the owner, licensee, buyer, broker and lawyers—to sign off on a transaction for patents. The workflow of the processes has been built to meet the current rules within the legacy registry system currently in use by the majority of national patent offices.

The registry will be capable of patent registration and increasing complex transactional capabilities in a global market context. By increasing transparency, it will help to unlock additional value in this asset class and reduce the liquidity discount associated with patents.

The present invention will be capable of allowing each step of a patent transaction, from recording the initial grant to the sale and licensing of transactions, to be recorded on blockchain and executed with smart contracts.

In one embodiment, the present invention will be further capable of incorporating regulatory, historical custom and infrastructure limitations applicable to patent registration and transactions.

In one embodiment, the DAPP will include a centralized interface and decentralized smart contract to streamline existing patent registration and transactions by, among other things, simplifying the registration process and making ownership information more accessible. Just finding patents and their respective owners is a complex process today that adds complexity to an already complex asset. This will result in increased transparency. In another embodiment, the present invention will facilitate transactions and recording of encumbrance information and permit and promot2 transactions within a decentralized system. In another embodiment, the present invention contains a ledger, that acts as the legal ledger of record for the patent asset class in some jurisdictions.

In another embodiment, for verified brokers & for the right types of assets, the present invention will be providing a guaranteed buy program. Under this program, the brokerage platform of the present invention will agree to buy a patent asset if it doesn't sell for a minimum bid value within a specified period. The brokerage platform will evaluate the asset using the analytics engine of the present invention to measure quality and validity, applying the valuation engine to attach a market value. The brokerage platform will then set 75% of this market value as the minimum bid for the patent asset. The asset is put up for bid for a specified period, with the bid closing 30 days after the minimum bid is hit. If the minimum bid value is not reached, the brokerage platform will commit to buy the asset for the agreed upon price.

### BRIEF DESCRIPTION OF THE DRAWINGS

The various embodiments are illustrated by way of example, and not by way of limitation, in the figures of the accompanying drawings in which:

FIG. 1 depicts the process by which smart contracts can be deployed to determine patent ownership.

FIG. 2 depicts the process by which the present invention can deploy a patent catalog,

FIG. 3 depicts the process by which the present invention can utilize smart contracts for ownership.

FIG. 4 is an illustrative diagram depicting a method of ownership transfer in the present invention.

FIGS. 5 is an illustrative diagram depicting a method by which various stakeholders participating in the present invention.

FIG. 6 is an illustrative diagram depicting one embodiment of the present invention.

FIG. 7 is an illustrative diagram depicting one embodiment of the present invention.

FIG. 8 is an illustrative diagram depicting one embodiment of the present invention.

FIG. 9 is an illustrative diagram depicting one embodiment of the present invention.

FIG. 10 is an illustrative diagram depicting one embodiment of the present invention.

FIGS. 11 is an illustrative diagram depicting an embodiment of the present invention using an object model.

FIGS. 12 is an illustrative diagram depicting the features of a portal page for the present invention and its participants.

FIGS. 13 is an illustrative diagram depicting various features of the present invention.

FIG. 14 is an illustrative diagram showing a use case for the present invention.

FIG. 15 is a diagram of the patent brokerage process of the present invention.

### DETAILED DESCRIPTION OF THE PREFERRED EMBODIMENT

The present invention seeks to provide a method of providing a robust method of registering, transferring, licensing, applying, and valuating IP assets using a decentralized ecosystem. This decentralized network will require at least one server, a processor, and at least one networking interface (“Network” or “IPwe Platform” or “IPwe”). Such a Network will allow the connection of user devices through the Internet. The Network itself will consist of at least one server, which will host a webpage, that when executed, will allow users to access a portal and be identified cryptographically using a private key and public key. The web portal or other network connected device will provide a platform to connect a patent owner with other stakeholders in the patent process.

In order for a decentralized system to function, one embodiment of the present invention envisions a patent ecosystem functioning on a blockchain network.

In one embodiment of the present invention, a transaction tool powered by smart contracts, combines solutions from the legal and payment industries to achieve a transparent system. IP is subsequently maintained in a Registry that is accessible using a decentralized application (“DApp”). Each party involved in a patent transaction—including the owner, licensee, buyer, broker and lawyers—can use the DApp to sign off on a transaction for patents.

In another embodiment, the workflow of the processes has been built to meet the current rules within the legacy registry system currently in use by the majority of national patent offices.

In one embodiment of the present invention, the decentralized network is a blockchain network. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems to provide a pooled resource for Patent owners and other stake holders.

A computer, network, or blockchain, may deploy a smart contract. A smart contract is computer code that implements transactions of a contract. The computer code may be executed in a secure platform (e.g., an Ethereum platform, IBM Hyperledger platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account, transfer the ownership of a patent). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct amount of tokens to and from the correct accounts.

The blockchain network may include multiple computers, networks, links, and databases. Miners may manage the blockchain, whereas the managing may include, for example, validating a smart contract and/or transaction according to the smart contract, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract.

The smart contract may determine the rules for evaluating a token price and an initial status of the token (such as the reserve of the token) and any other rules that should be applied during a transaction.

The above mentioned patent recordation method is transparent (As it can be viewed by various (usually all) participants of the blockchain network (and even other computers that are coupled to the blockchain network) smart contracts in a blockchain network in which the content of the smart contract and any transaction according to the smart contracts), and dramatically reduces the computer resources that should allocated with the transactions between different coins, and provides a robust system for patent searches, registration, brokering, transfers, and exchange (as it does not have a single point of failure).

In one embodiment of the present invention, a registry (“IPwe Registry”) is used to record information regarding patents on the blockchain. Each patent has an owner. The owner—also called the “applicant” when the patent is in the application stage and the “assignee” once the patent is issued—is encouraged, but not required, to file an assignment record with the various national patent offices to serve as evidence of ownership. These assignment databases are run by governmental organizations that receive the assignment information by fax, paper, or electronic filing—which then take weeks to record and become publicly available. In the USPTO, assignments of multiple patents or applications would have to be sent individually, so people typically fax assignments of multiple patents or applications instead of filing electronically.

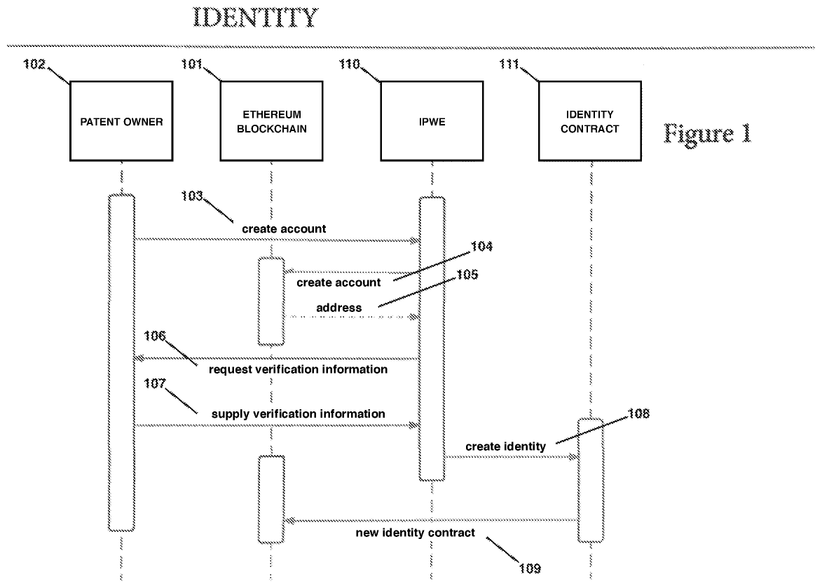

FIG. 1 illustrates an example of one embodiment of how a patent owner can participate in the patent process using the present invention. A patent owner 102, can create an account 103, with a service provider such as IPwe 110. The patent information provided by the patent owner 102, is then used by the IPwe Network 110 to create an account 104 on the Ethereum or the IBM Hyperledger Blockchain 101. This account has an address 105 that is relayed back to the IPwe Network 110. At any time, IPwe 110, can request verification information 106 from the Patent owner 102. The patent owner 102 can further can supply verification information 107 to IPwe 110. Independently, a third-party seeking information on that patent can deploy a smart contract 111, which seeks the identity of the owner of a patent 109. The IPwe platform request will automatically feed that information regarding the identity back to the smart contract 108.

In one embodiment the analytical tools made available through the IPwe Platform contain a database of most of patents from the major jurisdictions in the world—including China, major countries in the EU, Russia and the US. Utilizing traditional search methods, a user can identify patents from these jurisdictions in a given area of technology. Using predictive analytics present an assessment can be made of the likely applicability of a given patent to a product through a “relevancy score.” These relevancy scores can be used to narrow down the number of patents that are required to be reviewed from thousands to a more manageable number.

In another embodiment, artificial intelligence and predictive analytics will result in the ability for a user to further identify the most relevant patents for a product. In another embodiment, Intermediaries on the IPwe Platform will able to “tag” a patent on the IPwe Registry indicating that additional information is available with respect to a patent.

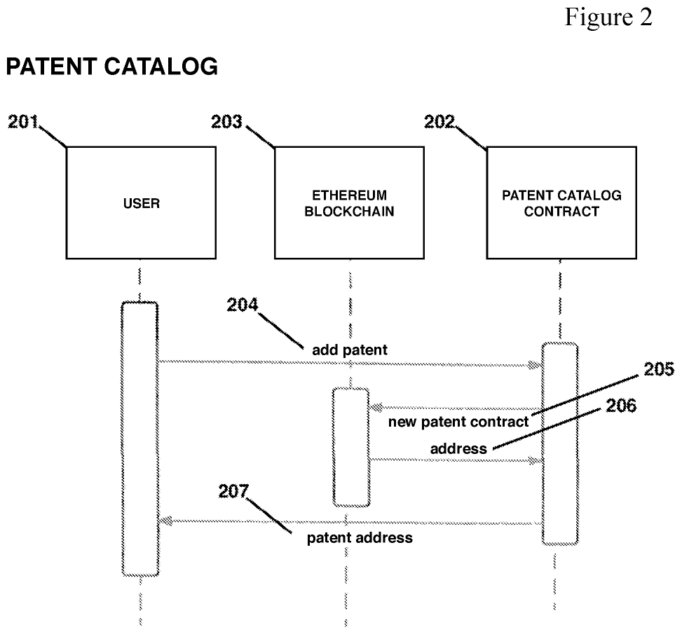

FIG. 2 illustrates one embodiment of the present invention, wherein a user 201 of the DApp can update the Ethereum or the IBM Hyperledger Blockchain 203 using a Patent Catalog Contract 203. The user 201 seeking to add a patent 204 to the catalog can use the DApp to initiate a smart contract known as the Patent Catalog Contract 202 that will update the Ethereum or the IBM Hyperledger Blockchain 204 with respect to that new data stored in the new patent contract 205. Each patent has an individual address 206 that is verified and sent back to the user 207 for safe keeping.

In one embodiment of the present invention, the IPwe Platform allow a reliable and more comprehensive database of patent transactions tied to the blockchain. Transactional history will be used to provide important reference points relevant to price discovery. In another embodiment, participants on the IPwe Network, or intermediaries will be encouraged—much as they are in other developed markets—to provide their views on valuation. Even with divergent views on valuation, intermediaries with experience and credibility will be rated and emerge and become important resources. These intermediaries with credibility stand to be rewarded through participation in the IPwe Platform. Artificial intelligence and predictive analytics can be used to establish relevant value.

In one embodiment of the present invention, the entire IPwe Network is powered by smart contracts. Using Blockchain technologies, IPwe Network and the IPwe Registry will be accessible as a decentralized application or (“DApp”) that allows each party to a patent transaction—including the owner, licensee, buyer, broker and lawyers—to sign off on a transaction for a patent. The workflow of the processes will be built to meet the current rules within the legacy registry system currently in use by various national patent offices.

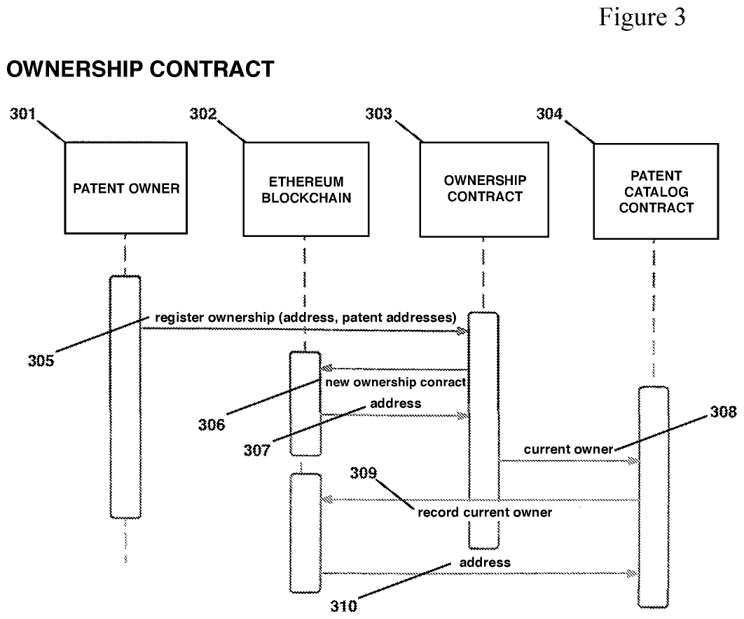

FIG. 3 illustrates one embodiment of the present invention, wherein the blockchain network passes ownership information. Specifically, a patent owner 301 registers ownership information, including address and patent addresses 303 using a smart contract called an ownership contract 303. The ownership contract passes the new ownership contract information 306 to the Ethereum or the IBM Hyperledger blockchain 302. The ownership information is further registered on the blockchain 305. A unique address 307 is passed is provided back to the owner through the ownership contract. The current owner 308 can then seek to register the information to Ethereum or the IBM Hyperledger Blockchain 302 via a Patent Catalog Contract 304 that records the ownership information 309 and provides a unique address 310 for the transaction.

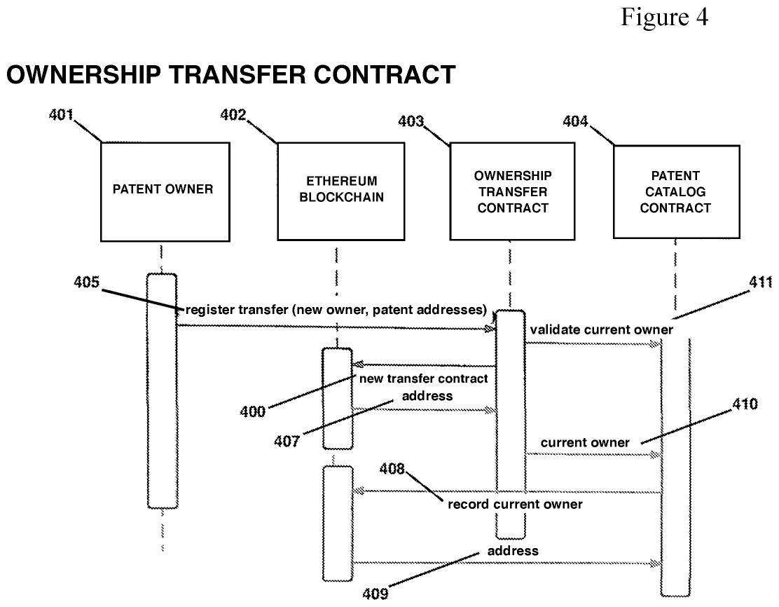

FIG. 4 illustrates an example of one embodiment of the present invention, wherein the blockchain network can be used to record transfer of ownership of patent assets. In particular, a patent owner 401 can register a transfer 405 via an ownership transfer contract 403. A new transfer contract 400 is executed on the Ethereum or the IBM Hyperledger blockchain 402 with a unique address 407. This can be done optionally with a smart contract 406. The current owner is validated 411 and a patent catalog 404 contract is issued 411. Information regarding the new owner is updated 408 and a unique transaction address 409 is recorded on a ledger.

The blockchain method can be utilized by various stake holders. In one embodiment, the present invention will include A SaaS IP Management software for corporations and law firms.

In another embodiment, the present invention may include a unified and connected view of all IP information, workflows and tasks using the blockchain network. Each user will have the ability to register the IP while other can viewed those registrations.

In another embodiment, patent examiners can compare past examinations to determine patentability of applications, thereby resulting in Accelerated Examination (assistance with searching/filing).

In another embodiment, all Defensive Publications include a verifiable date stamp. Our full text, searchable database is free to the public and accessible throughout the world.

In one embodiment, patent information registered on the IPwe Registry can be analyzed by competitors in order to propose a risk evaluation. The blockchain can present an organized view of patents and products in comparison to competitors' patents and products. The present invention will provide offensive and defensive analyses for each competitor help you evaluate potential litigation risks, expose gaps in competitive data, and recognize new licensing opportunities.

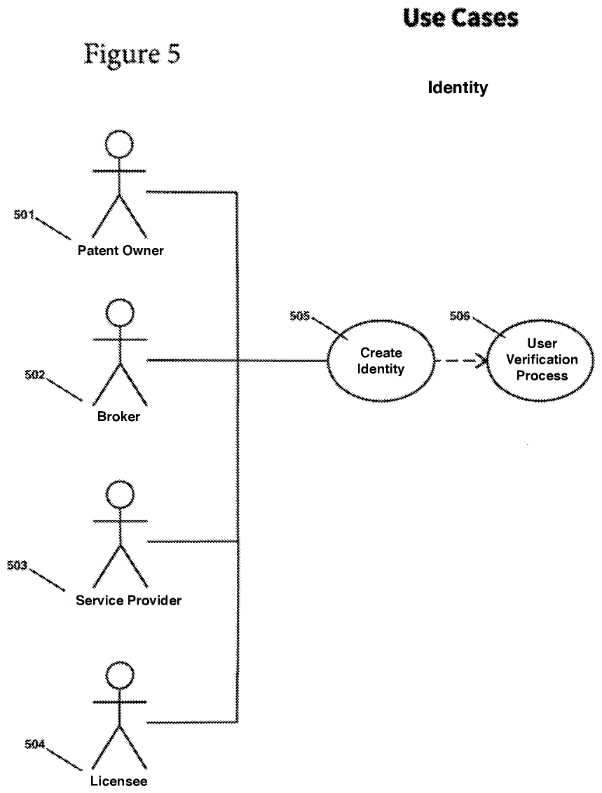

FIG. 5 illustrates an embodiment of the present invention depicting a use case of one embodiment of the present invention, wherein identity of various stake holders can be confirmed. Specifically, patent owner 501, a broker 502, a service provider 503, and a licensee 504 can all create identities 505 on the blockchain. Each user is verified through a verification process 506.

In one embodiment, the present invention will assemble third-party submissions (3PS) documents for patent registration.

In one embodiment, the present invention will provide assignee/ownership review methods.

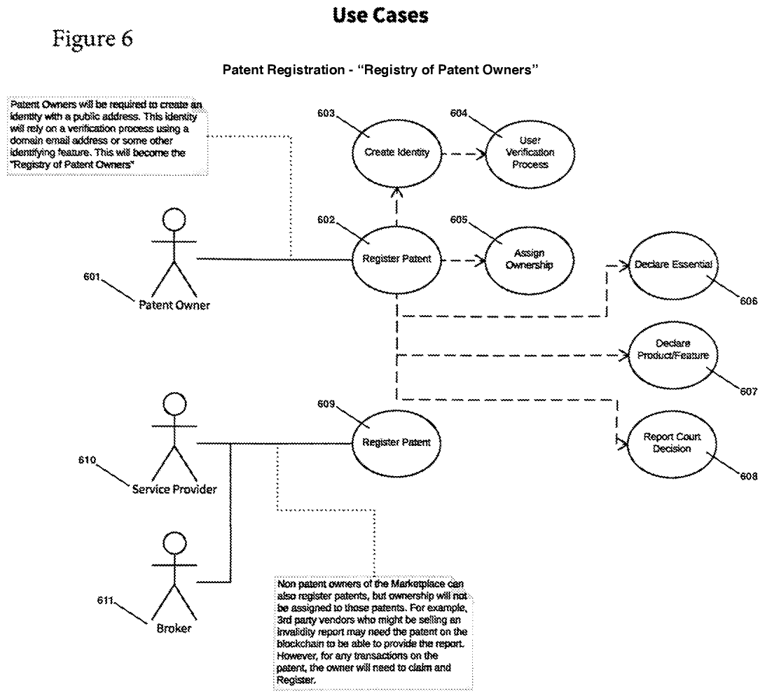

FIG. 6 illustrates an embodiment of the present invention depicting a use case wherein a registry of patent owners is maintained on the blockchain. A patent owner 601 can register a patent 602, create an identity 603 and have the identity verified through a verification process 604. The blockchain network further allows for assignment of ownership 605. The registered patent can be declared essential 606, declared as a product or feature 607 and have additional reports on based on court decisions 608. A Service provider 610 and Broker 611 can easily pull up information regarding registered patents 609.

In one embodiment, the present invention will provide an examination of a patent application leading to certification based on rules preprogrammed into a smart contract.

In one embodiment, the present invention will provide a claims analysis tool that can determine whether an invention is subject to prior art.

In another embodiment of the present invention, a collection of prior art can be assembled for an applicant seeking registration.

In another embodiment of the present invention, a competitive monitoring can show information regarding other registered patents or patent applications.

In another embodiment of the present invention, a concise description of asserted relevance of each document presented with a patent application can be provided.

In another embodiment of the present invention, a status of annuities and maintenance fees for each patent will be provided.

In another embodiment of the present invention, a user can use a virtual currency token to pay for patent maintenance on the blockchain network.

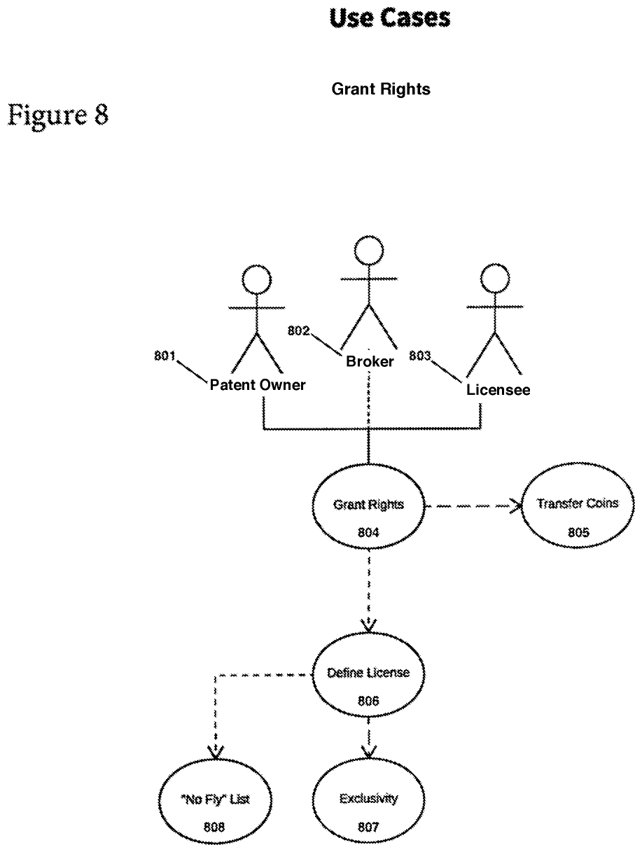

FIG. 8 illustrates an embodiment of the present invention depicting a use case wherein a patent owner 801 a broker 802 and a licensee 803 can all grant rights 804 in exchange for a transfer of virtual currency tokens or coins 805. They can define a licensee 806 that could either be included on a “no fly” list 808 or can have exclusive ownership or use rights 807.

In another embodiment of the present invention, the network can connect providers of corporate solutions, IP management software, IP support services, patent services, trademark services, and general legal support services.

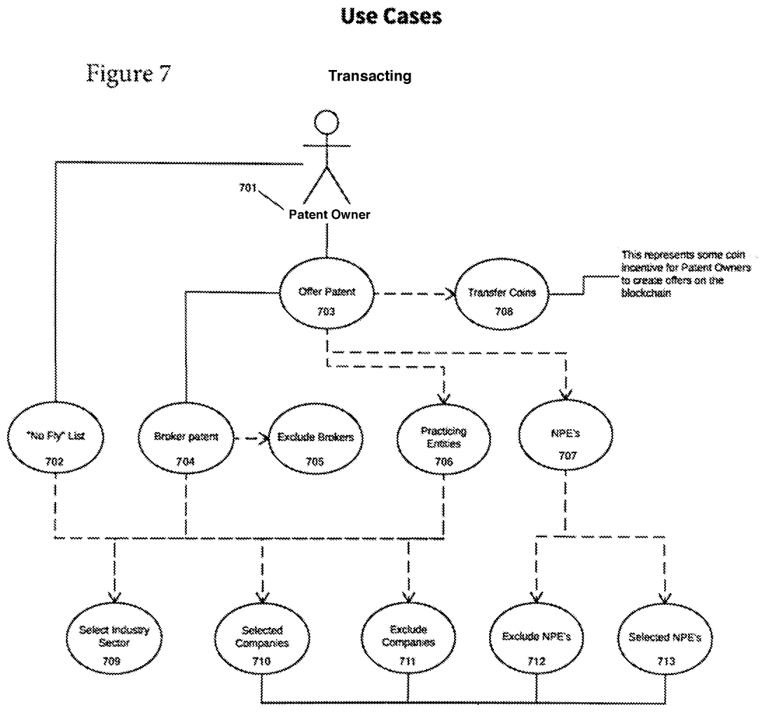

FIG. 7 illustrates an embodiment of the present invention depicting a use case wherein a transaction involving a patent can occur on the blockchain network. A patent owner 701 can be listed on a “No Fly” list 702. In addition, the Patent owner 701 can offer the patent 703 to other parties. A party that offers a patent on the system can be rewarded with tokens or virtual currency 708. Non practicing entities, depicted as NPEs 707, practicing entities 706 can offer the patent to brokers 704. The Brokers 704 can directly arrange deals regarding the patent as well 703. Brokers can contact exclusive brokers 705, select industry sectors 709, select companies 710, or exclude companies 711 based on a user criterion. NPEs can further be excluded 712 or included 713 based on a patent owner's strategy.

In another embodiment of the present invention, a copyright title or assignee search can be conducted through the network.

In another embodiment of the present invention, a court record research providing current and past assertions or patents identified during liability assessment can be provided for research.

In another embodiment of the present invention, a detailed disclosure can be generated by a smart contract for a patent applicant.

In another embodiment of the present invention, a user can subscribe to a Docket & Asset Management feature that would allow for full life cycle IP asset management for portfolio sizes ranging from tens of matters to tens of thousands of matters.

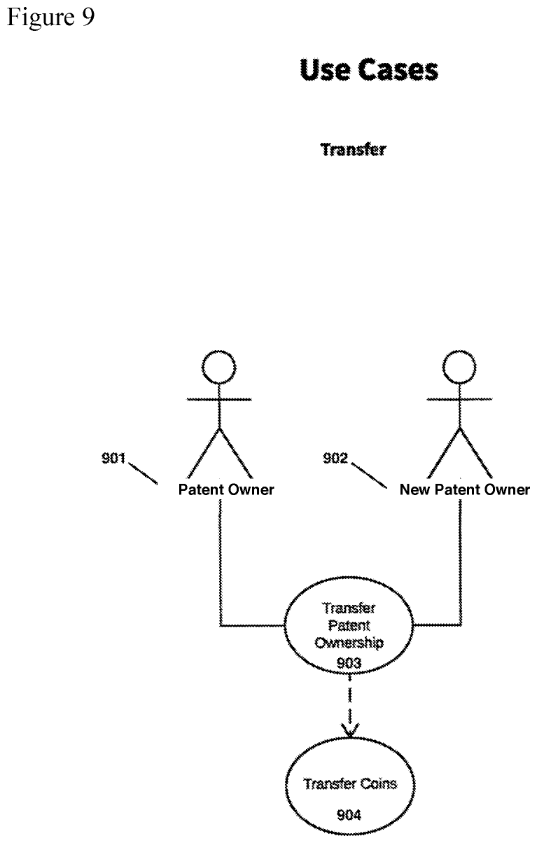

FIG. 9 illustrates an embodiment of the present invention depicting a use case wherein a Patent Owner 901 and a New Patent Owner 902 can agree on a transfer of Patent Ownership 903 from the former to the latter. This can be performed using a cryptocurrency token 904.

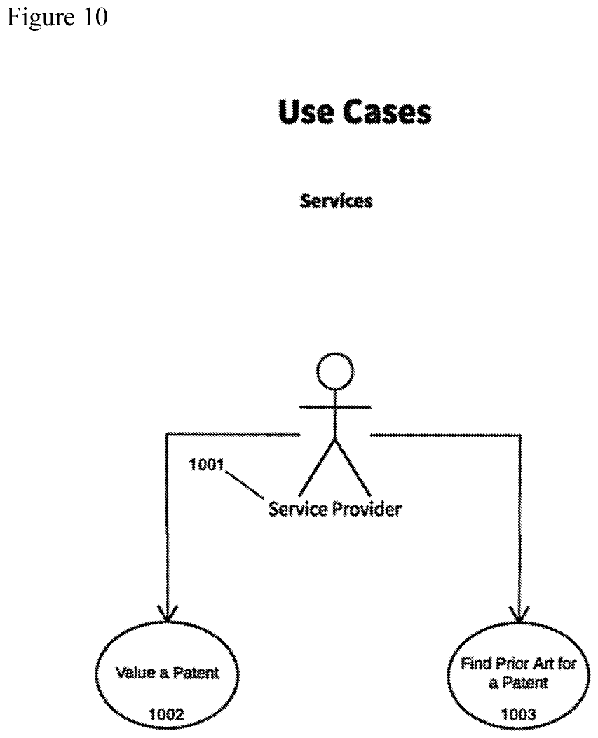

FIG. 10 illustrates an embodiment of the present invention depicting a use case wherein a service provider 1001 values a patent 1002 based on prior art found for a specific patent 1003.

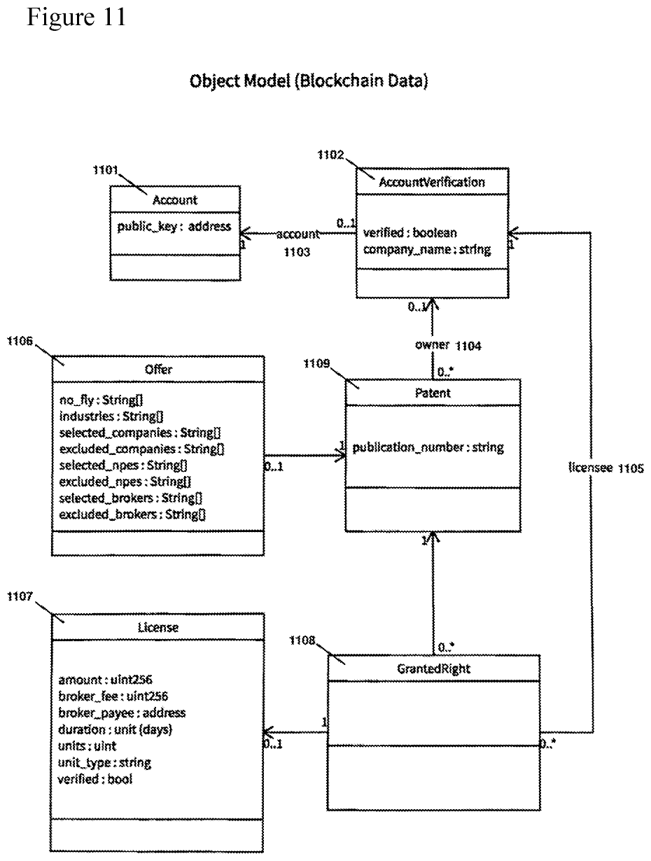

FIG. 11 illustrates an embodiment of the present invention depicting a use case wherein blockchain data is depicted using an object model. Specifically, an account 1101 contains a public key: address. A user who goes through account verification 1103 for an account 1102 using a software system containing a Boolean identifier and a company name category, can have a public key address associated with an account 1101. An offer 1106 by certain entities, companies, non-practicing entities, brokers, related to a patent 1109 is made and presented to an owner 1104. A License 1107 is granted 1108 to a payee who was given a right by either a verified patent owner, or a licensee 1105.

In one embodiment, the IPwe Network can provide a rating score associated with a search to find similar patents/applications. Each rating score will be based on a patent abstract, one step of forward/backward references, classification, two steps of forward/backward references and similar text.

In one embodiment, the present invention may utilize a DApp. This will allow a quick method of connecting innovators, patent owners, intermediaries and others to streamline the process for creating, evaluating and transacting in patents.

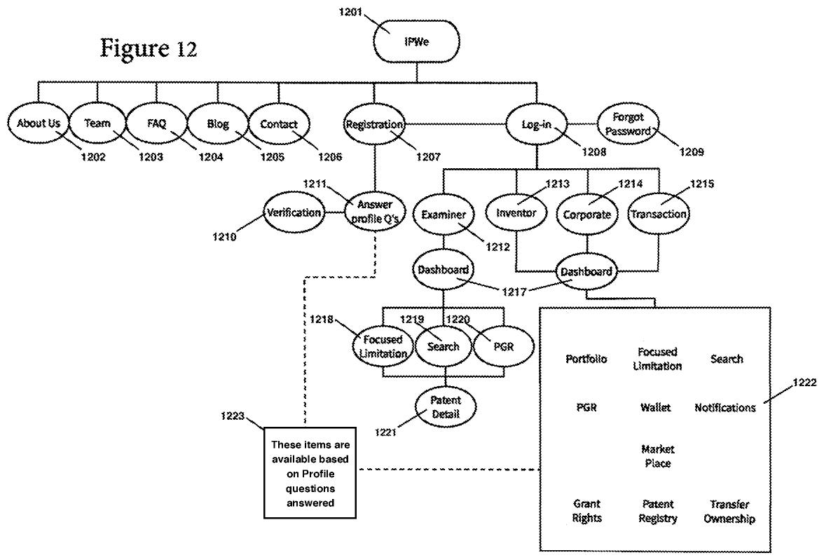

FIG. 12 illustrates an embodiment of the present invention wherein the IPwe network is accessible through an online 1201 portal page giving information in an About Us 1202 section, a Team 1203 section, a frequently asked questions section 1204, a Blog 1205, and a contact section 1206. The portal page further allows registrations 1207 based on a user input answering questions 1211 which are verified 1210. A verified user that logs in 1208 can access password information through a forgot password section 1209. The user can be an examiner 1212, an inventor 1213, a corporate entity 1214, or simply a transactional entity 1215. Each of users will have a dashboard 1217, with the Inventor 1213 Corporation 1214, and Transactional entity 1215 being presented with a set of unique options such as view portfolio, focused limitations, search inquiries, wallets, notifications, Analytics such as Zuse analytics or PGR analytics, Market Place information, Grant Rights, Patent Registry and Transfer Ownership 1222. An examiner on the other hand can see focused limitations 1218, search information 1219, Analytic tools such as Zuse analytics or PGR analytics 1220, and Patent Detail 1228. All of this information is based on profile questions that were answered 1223. The information can be passed to Intellectual property brokers 1216.

In one embodiment of the present invention, intermediaries such as traditional counsel that rely on inefficiencies to justify outrageous fees and “solution” providers like patent aggregators and trolls that exist simply to exploit inefficiencies in the patent system will cease to exist and can be excluded from the IPwe platform. Large and small patent owners and innovators that seek to capture the benefits of the patent system and operators that are constantly seeking new technologies to exploit will benefit from the IPwe platform.

In one embodiment of the present invention, the platform will consist of a community made up of, Innovators: The people and companies that genuinely create and patent, Scholars and researchers: The body of knowledge contained in millions of patent specifications, R&D: A significant percentage of R&D expenditure is duplicative of efforts that are reflected in the prior art, but difficult to access, and/or Patent Prosecution: Attorneys

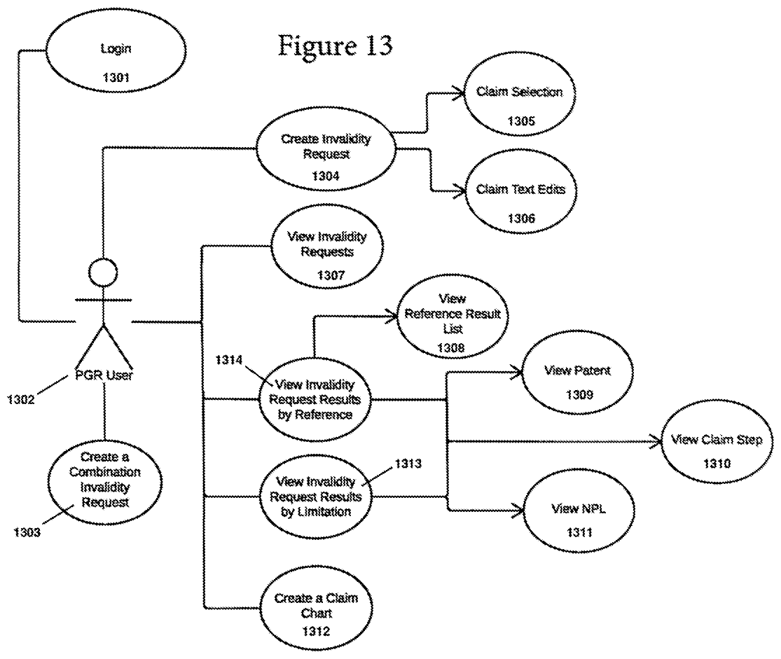

FIG. 13 illustrates an embodiment of the present invention wherein a Patent Registry User 1302 can login 1301 and create an invalidity request 1303. Such a request 1304 will result in changes to claim sections 1305 or claim text edits 1306. Invalidity requests can be viewed by the user 1307, they can be viewed by reference 1314, by limitation 1313, and can be used to generate a claims chart 1312. They can generate a reference list result 1308, can allow a user to directly view a potential patent that is blocking registration 1309, view claim steps 1310 and view non-practicing language 1311.

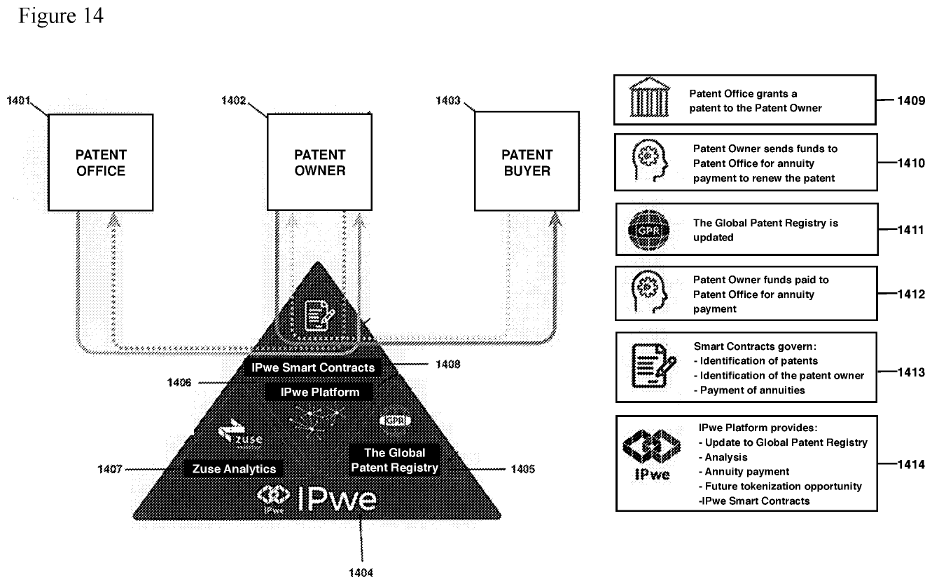

FIG. 14 illustrates an embodiment of the present invention wherein the analytic tools such as PGR or Zuse Analytics 1407 can be combined with the IPwe 1404 Platform 1406 to create a Global Patent Registry 1405 that can be used to connect a patent owner 1402 with various patent offices 1401 and potential third parties such as patent buyers 1403. All of this is performed using smart contracts 1408. Interesting to note is that the patent office grants the patent to the patent owner 1409, and the IPwe Network 1414 gives the Owner 1402 the ability to update the global registry 1411 send annuity payments 1410 through smart contracts that govern the identification of patents, patent owners funds can be paid to the patent office for annuity payments 1412, the identification of owners and the deadlines to pay such annuities 1413.

In one embodiment, the IPwe Network is maintained by a central organization, and run by various stakeholders. Each of those stakeholders can receive funding in the form of virtual currency or FIAT currency in the form of commission revenue from patent transaction, registration fees, services revenue.

In another embodiment, the IPwe platform can provide a crowd source purchasing of patents for individual owners seeking to raise funding.

In one embodiment of the present invention, a network is configured such that a document list identifying publications, or portions of publications being submitted can be created.

In one embodiment of the present invention, a network is configured to autonomously use historical data to draft concise descriptions of the asserted relevance submitted documents and publications.

In one embodiment of the present invention, the network is configured to conduct Due Diligence Services Include the following: E-Discovery—Data Forensics, Data Processing, Hosted Review, English language translations for foreign language references

In one embodiment of the present invention, the network is configured to allow for smart contracts to conduct Examination of IP applications.

In another embodiment of the present invention, the network is configured to allow for an examiner to directly examine applications using historical and other data. In one embodiment of the present invention, the network is configured to allow for the filing of US and PCT applications.

In one embodiment of the present invention the network is configured to autonomously conduct clearance searches with respect to patent applications.

In one embodiment of the present invention, the network is configured to further record historical litigation analysis for patent cases.

In one embodiment of the present invention, the network is configured to provide insight using historical data as to gaining revenue off patents.

In one embodiment of the present invention, the network is configured to provide insight using historical data as to minimizing overhead expenses related to IP registration.

In one embodiment of the present invention, the network is configured to provide insight using historical data as to obtaining venture capitalist funds.

In one embodiment of the present invention, the network is configured to provide insight using historical data as to how to reward and incentivize inventorship.

In one embodiment of the present invention, the network is configured to provide insight using historical data as to how to track competitors.

In another embodiment, the stakeholders are intermediaries that help maintain various aspects of the network.

In one embodiment of the present invention, the network is configured to provide Innovation Support, IP Portfolio Support, IP Intelligence Software Ideas, Invention, Search, Watch, Docketing, Forecasting, Filing, Recordals, and Analytics.

In one embodiment of the present invention, the network is configured to provide Invention Brainstorming Sessions—wherein Intermediaries will have brainstorming sessions to support your innovation process. This customizable offering will provide a range of services such as developing pre-session brainstorming materials for your inventors, offering continuous patentability analysis during the session, and providing disclosure write up after the session.

In one embodiment of the present invention, the network is configured to provide Invention Disclosure Evaluation & Analysis System that provides a simple online interface for your inventor community to submit disclosures. The intuitive design makes invention submission easy, providing your inventors with information about where the disclosure is in the review or patenting process.

In one embodiment of the present invention, the network is configured to provide Defensive Publications.

In one embodiment of the present invention, the network is configured to provide Dashboard tools such that Defensive Publication offerings can be integrated into the invention disclosure process, using a management platform.

In one embodiment of the present invention, the network is configured to provide Detailed Disclosure Assistance. The network will be configured to allow connection to experts that can expand upon a patentee's disclosures, fill out a more complete description of the invention and background of the technology area.

In one embodiment of the present invention, the network is configured to provide Knock Out Patentability, Landscape Viewer, Landscape search, Whitespace search.

In one embodiment of the present invention, the network is configured to provide data regarding due diligence for patent portfolios connected with mergers and acquisitions.

In one embodiment of the present invention, the network is configured to provide Portfolio monetization, assertion studies, and IP valuation.

In one embodiment of the present invention, the network is configured to apply for, register, renew and maintain trademark applications, copyright applications and other intellectual property asset application.

In one embodiment the present invention contains a ledger that mirrors official (unique and different) patent registry ledgers to being an official ledger of record (for multiple worldwide patent registries). This allows governments to transfer recognition of legacy databases as the exclusive legal evidence of ownership and liens. In this embodiment, the blockchain network can be used to conduct business and simply mirror government records while providing a platform for the patent ecosystem to conveniently and remotely confirm and transact in the patent asset class.

In another embodiment blockchain and smart contracts are used to increase transparency and reduce inefficiencies. using blockchain, smart contracts and an experienced team of intellectual property and technical professionals to the patent ecosystem will leverage the Platform will resolve the issues related to determining ownership, identification, coverage and value and to promote. Using a blockchain-enabled patent registry platform coupled with smart contract functionality, the IPwe Registry patent registry enables market participants to quickly establish the owner of a patent through a decentralized database. This will encourage large and small patent owners to record their patents in the IPwe registry.

In one embodiment, the IPwe Registry can be adopted by smaller national patent offices to record patent ownership and related information. In another embodiment the national patent offices (and 10 regional patent offices) will adopt the IPwe Registry as their official ledger of record to record patent ownership and the transfer of patent assets, with the IPwe Registry becoming the official record of ownership, legal transfer and registration of any transfers. By leveraging the IPwe Registry and the IPwe Platform, unnecessary delays and impediments inherent in legacy patent registration systems will be eliminated and ownership information will be readily available to the patent ecosystem.

In one embodiment, the present invention contains a method of transactions wherein all fees, payments, purchases, and services are transacted using virtual currency, or cryptocurrency. The Network can further reward various stakeholders for participation within the network using the same cryptocurrency tokens. Each token can be traded or transacted using various systems and converted to FIAT currency. Such a system is applicable as a blockchain network.

In another embodiment, for verified brokers & for the right types of assets, the present invention will be providing a guaranteed buy program. Under this program, the brokerage platform of the present invention will guarantee a buy rate for an intellectual property asset if it doesn't sell for a minimum bid value within a specified period. The brokerage platform will evaluate the asset using the analytics engine of the present invention to measure quality and validity, applying the valuation engine to attach a market value. The brokerage platform will then set a percentage of this market value as the minimum bid for the patent asset. The asset is put up for bid for a specified period, with the bid closing a predetermined number of days after the minimum bid is hit. If the minimum bid value is not reached, the brokerage platform will commit to buy the asset for the agreed upon price.

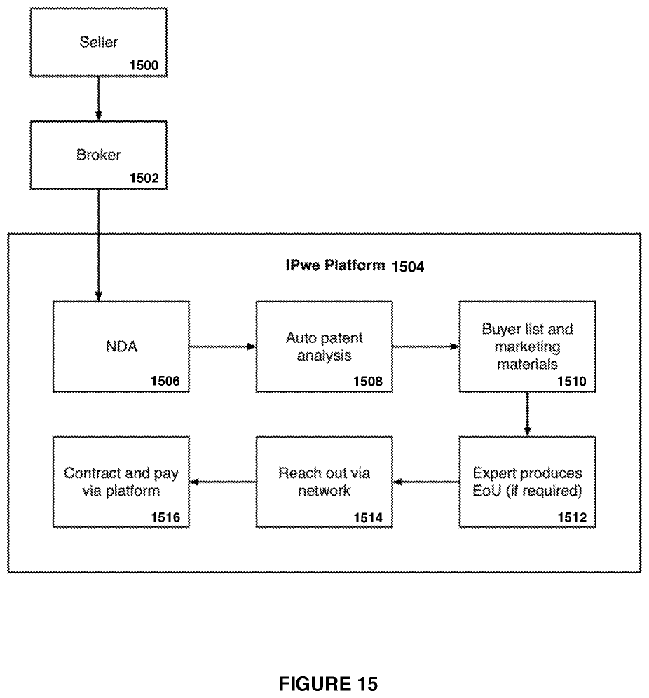

In another embodiment, the brokerage platform will set 75% of the market value as the minimum bid for the patent asset. In addition, the bid closing 30 days after the minimum bid is hit. FIG. 15 is a diagram of the patent brokerage process of the present invention. In accordance with the preferred embodiment of the present invention, the seller 1501 reaches out the broker 1502 with patent assets for sale. The broker 1502 signs the seller 1501 up to the IPwe Platform 1509. The IPwe platform 1509 then handles any non-disclosure agreements 1503. Then, the IPwe Platform 1509 performs an automated patent analysis 1504 and generates a buyer list and marketing materials 1505. If required, an expert produces an EoU 1508, and the IPwe Platform 1509 performs outreach via the platform network 1507. Finally, contract and payment 1516 is done through the IPwe Platform 1506.

In one embodiment, the guaranteed buy back will be a predetermined value that is provided by the platform.

In another embodiment, the guaranteed buy back will be in the form of an offer to exchange virtual currency in exchange for the purchase of an intellectual property asset.

In one embodiment, a intellectual property asset can be sold for either virtual currency tokens or FIAT currency.

In one embodiment, the platform may present multiple options as to the guaranteed buy back, showing the value of the asset in FIAT currency, and providing the option to purchase the asset for a number of virtual currency tokens at the current market rate.

In one embodiment, the platform may further give the option to buy an intellectual property asset in FIAT currency or virtual currency, whichever is lower at the time of the buy back.

In one embodiment, the platform may further give the option to buy an intellectual property asset in FIAT currency or virtual currency, whichever is higher at the time of the buy back.

In one embodiment, a criterion related to broker verification is provided to prospective brokers. The brokers can then submit data requested and be approved as a verified broker. Under such an embodiment, the benefits of a guaranteed buy program are provided only to verified brokers.

In one embodiment, the guaranteed buy program is established for all patent assets listed on the global patent registry.

In another embodiment, the broker is given a fee based on the total transaction value on the sale of IP assets.

In one embodiment, the broker may or may not be the owner or assignee of the patent asset.

In another embodiment the broker is an individual hired to assist the patent owner or assignee to monetize a patent asset.

In one embodiment the platform compensates brokers to find buyers for patent assets. The broker chosen based on experience in a specific field. By way of example, a patent portfolio related to aerospace technology may be assigned to a broker who has experience in said industry.

In another embodiment, the broker is not paid any type of commission for referrals.

In one embodiment, the guaranteed buy back offer can be made to any person or entity trying to purchase or sell an asset on the platform. This can apply to brokers, patent owners, assignees or others.

In one embodiment a commission is paid to anyone who finds a buyer for a patent asset.

In one embodiment, the patent owner has an option to pay a broker and not a seller or purchaser in exchange for handling the transaction.

In one embodiment the patent owner may choose to have a broker handle the transaction despite other sellers being involved.

In one embodiment, any person who finds a buyer for patent assets receives a percentage-based commission from the platform commission.

In one embodiment, any person who refers a seller for patent assets receives a percentage-based commission from the platform commission.

In one embodiment, any person who refers a seller for patent assets receives 25% commission from the platform commission.

In one embodiment, any person who refers a seller for patent assets receives 25% commission from the platform commission.

In another embodiment, a platform ambassador receives 10% commission from the platform transaction fee for referring a seller.

In one embodiment the broker adds a fee on top of their commission for signing up a seller.

In one embodiment, a broker receives verified status based on the amount of IP the broker has listed on the IPwe Platform.

In one embodiment, a broker receives verified status based on community syndication.

In one embodiment, a broker receives verified status based on the value of the transactions conducted on the IPwe platform associated with that broker.

In one embodiment, a seller may list intellectual property assets for sale on the platform. The platform may provide an offer to buy the intellectual property assets if they do not sell within a predetermined amount of time. The offer to buy may include a guaranteed purchase price, the guaranteed purchase price being a fixed percentage of the list price, a fixed percentage of the highest bid price, or a predetermined fixed price. The seller may elect to accept this guaranteed price purchase. The offer to purchase the intellectual property assets may be in FIAT currency or in virtual currency tokens.

In one embodiment, the platform can provide debt financing for the purchase of a patent asset.

In another embodiment the platform can cover any gaps with respect to the requested debt.

In one embodiment of the present invention, the platform can limit the time period for a financing total.

In another embodiment, the guaranteed buy back is conditioned about meeting of specific milestones.

In another embodiment, a broker establishes a commission fee split between transacting parties using any method.

In one embodiment the platform charges a fee for royalty monitoring and ongoing payment management or enforcement.

In another embodiment, the platform charges a commission on the financing value. If a broker induces a patent owner to transact on the platform, the broker will be entitled to some reward or compensation.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain the, decentralized transactions can take place.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removable or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of.”

What is claimed is:

1. A method for guaranteeing value of intellectual property assets, the method comprising:
evaluating the status of an intellectual property broker based on predetermined criteria;
determining whether the broker has a verified status;
evaluating at least one intellectual property asset listed on a blockchain intellectual property transaction network, the intellectual property asset further capable of being associated with at least one broker having verified status;
listing the intellectual property for sale on the blockchain intellectual property transaction network;
evaluating bids for the intellectual property asset listed for sale on the intellectual property transaction network;
executing code recorded on the blockchain IP transaction network, which offers a guaranteed buy rate associated in exchange for the least one intellectual property asset that meets the evaluation criteria;
recording the change of ownership of the intellectual property asset on the blockchain intellectual property network;
transferring an amount guaranteed buy rate to the former owner of the intellectual property owner.
recording the transfer on the blockchain intellectual property network; and
rewarding the at least verified broker associated with the at least one intellectual property asset.

2. The network of claim 1, further comprising:
a plurality of nodes, wherein each node in the plurality of nodes is configured to transact autonomously with at least two nodes in the plurality of nodes and configured to communicate with at least one server;
the at least one server, the at least one server comprising at least one hardware processor, a non-transitory machine-readable storage medium having an executable computer readable program code, the at least one hardware processor configured to execute the computer-readable program code;
the server, capable of identifying at least one account holder using a private key and a public key and connected to an at least one user device; and
the user device capable of communicating with the plurality of nodes;

3. The method of claim 1, wherein the at least one verified broker is rewarded using virtual currency.

4. The method of claim 1, wherein the at least one verified broker is rewarded using FIAT currency.

5. The method of claim 1, where a network fee is charged for any intellectual property related transactions conducted on the blockchain intellectual property network.

6. The method of claim 1, where a royalty rate is charged for maintaining IP assets.

7. The method of claim 1, where the guaranteed buy rate is based on historical data of similar intellectual property assets.

8. The method of claim 1, wherein the code executed on the blockchain intellectual property network can only be executed after a specific number of days.

9. The method of claim 1, wherein the code executed on the blockchain intellectual property network comprises a smart contract.

10. A decentralized network for selling intellectual property assets, the decentralized network comprising:
at least one hardware processor, a non-transitory machine-readable storage medium having executable computer readable program code, the at least one hardware processor configured to execute the computer-readable program code to:
list an intellectual property asset for sale on the network;
determine a guaranteed value of the intellectual property asset;
receive a request from a requester execute a smart contract;
the smart contract containing at least one term governing the minimum bid price of an intellectual property asset, the guaranteed value of the intellectual property asset and a broker status;
receive a request to validate the completion of the at least one term of the smart contract,
validate the completion of the at least one term of smart contract;
transfer ownership of the intellectual property asset; and
update a ledger with the ownership information;
reward a broker with a verified status; and
transferring a guaranteed value to the requester of the smart contract.

11. The decentralized network of claim 10, where the guaranteed buy back value of the intellectual property asset is based on predetermined criteria.

12. The decentralized network of claim 10, where the intellectual property asset is listed for sale in terms of cryptocurrency or FIAT currency.

13. The decentralized network of claim 10, wherein the broker reward is based on the overall value of the intellectual property asset.

14. The decentralized network of claim 10, wherein the broker reward is based on a predetermined amount.

15. The decentralized network of claim 10, wherein the requester of the smart contract transfers virtual currency tokens equal to the guaranteed value.

16. The decentralized network of claim 10, wherein the broker with a verified status is rewarded with cryptocurrency tokens.

17. The decentralized network of claim 10, wherein the requester is transferred FIAT currency equal to the guaranteed value.

18. The decentralized network of claim 10, wherein the broker is rewarded with FIAT currency.

19. The smart contract of claim 10, further including at least one rule related to the length of time an intellectual property is listed for sale.

20. The decentralized network of claim 10, further configured to measure the quality of the intellectual property asset based on historical data.

21. Decentralized network of claim 10, where a royalty rate is charged for maintaining intellectual property assets.
